(19) United States
(12) Patent Application Publication
(10) Pub. No.: US 2026/0304205 A1
(43) Pub. Date: Oct. 1, 2026

(54) ARTIFICIAL INTELLIGENCE-NATIVE FLOW-TO-BEARER MAPPING

(71) Applicant: QUALCOMM Incorporated, San Diego, CA (US)

(72) Inventors: Sherif Elazzouni, San Diego, CA (US); Sitaramanjaneyulu Kanamarlapudi, San Diego, CA (US); Gavin Bernard Horn, La Jolla, CA (US); Ozcan Ozturk, San Diego, CA (US)

(21) Appl. No.: 19/091,308

(22) Filed: Mar. 26, 2025

(51) Int. Cl. H04W 28/02; H04L 41/0803

(52) U.S. Cl. CPC H04W 28/0252; H04L 41/0803

(57) ABSTRACT

Techniques related to wireless communication are disclosed. Aspects of the disclosure include a User Equipment (UE) comprising: one or more memories; one or more processors coupled to the one or more memories, the one or more processors configured to: obtain a flow; and perform a bearer selection process to select, from among a plurality of data radio bearers configured for use by the UE to transmit flows on a network, a data radio bearer for transmission of the flow; and a radio configured to transmit at least some of the flow on the selected data radio bearer. Other aspects, embodiments, and features are also claimed and described.

### TECHNICAL FIELD

The technology discussed below relates generally to wireless communication systems, and more particularly, to configuring User Equipment for transmitting flows.

### BACKGROUND

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

As described herein, a User Equipment (UE) may obtain a flow and perform a bearer selection process to select a data radio bearer (DRB) for the flow from among a plurality of data radio bearers configured for use by the UE to transmit flows on a network. A radio of the UE may be configured to transmit at least some of the flow on the selected data radio bearer. The UE selecting the DRB for the flow may enable the UE to proactively select a DRB for the flow given conditions at the UE. This may decrease congestion and increase overall data at the UE.

In one example, this disclosure describes a User Equipment (UE) for wireless communication, the UE comprising: one or more memories; a radio; and one or more processors coupled to the one or more memories, the one or more processors configured to cause the UE to: obtain a flow; perform a bearer selection process to select, from among a plurality of data radio bearers configured for use by the UE to transmit flows on a network, a data radio bearer for transmission of the flow; and transmit, via the radio, at least some of the flow on the selected data radio bearer.

In another example, this disclosure describes a method for wireless communication, the method comprising: obtaining, by a User Equipment (UE), a flow; performing, by the UE, a bearer selection process to select, from among a plurality of data radio bearers configured for use by the UE to transmit flows on a network, a data radio bearer for transmission of the flow; and transmitting, by a radio of the UE, at least some of the flow on the selected data radio bearer.

In another example, this disclosure describes one or more non-transitory computer-readable storage media having processor-executable instructions stored thereon that, when executed by one or more processors of a User Equipment (UE), cause the UE to: obtain a flow; perform a bearer selection process to select, from among a plurality of data radio bearers configured for use by the UE to transmit flows on a network, a data radio bearer for transmission of the flow; and transmit, via a radio of the UE, at least some of the flow on the selected data radio bearer.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a schematic illustration of a user plane protocol stack and a control plane protocol stack in accordance with some aspects of this disclosure.

FIG. 3 is a block diagram illustrating an example of a hardware implementation for a network node employing a processing system.

FIG. 4 is a flow chart illustrating an exemplary process for wireless communication in accordance with some aspects of the present disclosure.

FIG. 5 is an illustrative block diagram of an example machine learning (ML) model represented by an artificial neural network (ANN)

FIG. 6 is an illustrative block diagram of an example ML architecture that may be used for wireless communications in any of the various implementations, processes, environments, networks, or use cases listed above.

### DETAILED DESCRIPTION

A flow may be a specific stream of data packets that share the same characteristics and requirements. A flow may also be referred to as a traffic class. A data radio bearer (DRB) is a communication channel that carries data between the user equipment (UE) and the network in wireless communication systems. Flows may be mapped to DRBs. When a flow is mapped to a DRB, a User Equipment (UE) uses the communication channel of the DRB to transmit data packets of the flow. In 5G, the flow-to-bearer mapping is dynamic but is controlled by a network entity and not by a UE. Specifically, the network entity may use Service Data Adaptation Protocol (SDAP) signaling to specify the flow-to-bearer mapping to the UE. Flows may be marked with a Quality of Service (QoS) flow identifier (QFI) in both downlink (DL) and uplink (UL) packets. Reflective QoS at an access stratum (AS) level (RDI) or Reflective QoS at a Non-Access Stratum (NAS) level (RQI) may be used for applying QoS parameters. A network entity may use RDI or RQI to provide a UE with a mapping from QoS flow to DRBs. The DRB mapping (e.g., assignment) may determines the packet rules in the RAN including discarding, prioritization, buffer size reporting, and so on. The use of SDAP for assignment of flows to DRBs may include the ability to update QoS rules without heavy radio resource control (RRC) or Non-Access Stratum (NAS) signaling overhead, with signaling savings. Additionally, the use of SDAP for assignment of flows to DRBs with QFI headers may allow multiplexing of different QoS flows on the same radio bearer. Furthermore, the use of SDAP for assignment of flows to DRBs may enable QoS-related optimizations, such as reorder, discard, etc.

While different flows may be mapped to different DRBs in 5G, this was seldom done. Rather, all flows were typically mapped to one or two DRB. Static mappings of applications to DRBs were typically employed. For instance, voice flows may be mapped to a first DRB and data flows may be mapped to a second DRB. Additionally, the SDAP was mostly unused by network vendors and operators. In general, all flows assigned to a DRB are treated the same. Thus, flows mapped to a DRB compete for resources.

The emerging 6G wireless communication technologies are expected to increase integration between applications and radios. It is expected that a UE would have access to more information about the current and future states of applications. For example, it is expected that, for a video bearer applying an adaptive bit rate, the UE would have access to information regarding whether the application has reduced its needs in terms of bit rate. However, this information is not currently used to improve transmission efficiency.

The relatively fixed flow-to-bearer mappings may result in several different problems. For example, a UE may be configured with multiple data radio bearers. In this example, a first flow and a second flow may mapped to a single DRB. The first flow may provide data packets at a relatively steady rate while the second flow provide data packets in bursts. The bursts of data packets may cause a Packet Data Convergence Protocol (PDCP) queue of the DRB to enter a flow-control mode and start dropping data packets. In this example, a network entity that would otherwise assign flows to DRBs would not obtain information indicating that data packets are being dropped from the PDCP queue because the flow-control mode happens before a PDCP sequence number is assigned. Thus, the bursty second flow is hurting the abilities of the other flows to communicate their data packets by causing packet drops. In this example, it would be useful for the UE to isolate the bursty second flow to another DRB so that the other DRB is able to absorb the bursts of the second flow without hurting the abilities of the other flows to communicate their data packets.

In another example, it is observed that when newer flows and older flows are assigned to the same DRB, the newer flows are penalized by being queued behind the older flows. In general, the older, long-lived flows have already reached their steady state throughput and consume most of the bandwidth of the DRB as the newer flows pick up their throughput. However, it would be advantageous for newer flows to be mapped to uncongested DRBs and then later move the newer flows to default DRBs as the newer flows converge to their steady state throughput levels.

In another example, traffic of all importance levels may be mapped to the same DRB. However, if the DRB is congested, high-importance packets such as Transmission Control Protocol (TCP) acknowledgments may be delayed. Such delays might be avoided if the high-importance packets were instead mapped to a less congested DRB. Furthermore, in some examples, a UE may suspend one or more DRBs to reduce power consumption, e.g., in high thermal conditions, while continuing use of one or more other DRBs. This may prevent the UE from transmitting data packets of the flows assigned to the suspended DRBs even though the data packets of the flows could be transmitted on one of the other DRBs.

The techniques of this disclosure may address one or more of these issues. As described herein, a UE may obtain a flow and perform a bearer selection process to select, from among a plurality of data radio bearers configured for use by the UE to transmit flows on a network, a data radio bearer for transmission of the flow. A radio of the UE may be configured to transmit at least some of the flow on the selected data radio bearer. By allowing the UE to perform the bearer selection process, the UE may be able to transmit the flow on a DRB so that overall transmission rates may be increased.

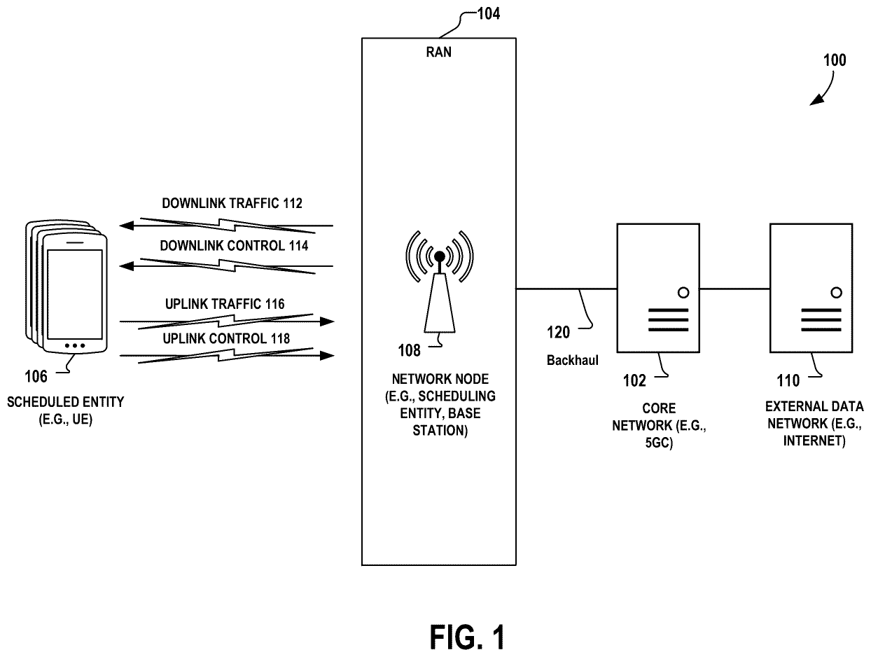

FIG. 1 is a schematic illustration of a wireless communication system 100 according to some aspects of this disclosure. The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, UE 106 may be enabled to carry out data communication with an external data network 110, such as (but not limited to) the Internet.

RAN 104 may implement any suitable wireless communication technology or technologies to provide radio access to UE 106. As one example, RAN 104 may operate according to 3rd Generation Partnership Project (3GPP) New Radio (NR) specifications, often referred to as 5G or 5G NR. In some examples, RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, RAN 104 includes at least one network node 108. In some examples, RAN 104 includes multiple network nodes. Broadly, a network node is a network element in a radio access network responsible for radio transmission and reception in one or more cells to or from a UE. In different technologies, standards, or contexts, those skilled in the art may variously refer to a “network node” as a base station, a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, and so on that are electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between RAN 104 and UE 106 may be described as utilizing an air interface. Transmissions over the air interface from a base station (e.g., network node 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network node 108). Another way to describe this scheme may be to use the term broadcast channel multiplexing. Transmissions from a UE (e.g., UE 106) to a base station (e.g., network node 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity such as network node 108.

Network nodes and base stations are not the only entities that may function as scheduling entities. That is, in some examples, a UE or network node may function as a scheduling entity, scheduling resources for one or more scheduled entities (e.g., one or more UEs).

As illustrated in FIG. 1, network node 108 may broadcast downlink traffic 112 to one or more UEs 106. Broadly, a network node is a node or device responsible for scheduling traffic in a wireless communication network, including downlink traffic 112 and, in some examples, uplink traffic 116 from one or more UEs to network node 108. On the other hand, UE 106 is a node or device that receives downlink control information 114, including but not limited to scheduling information (e.g., a grant), synchronization or timing information, or other control information from another entity in the wireless communication network, such as network node 108. UE 106 may transmit uplink control traffic 118 to network node 108.

Network node 108 may include a backhaul interface for communication with a backhaul network 120 of wireless communication system 100. Backhaul network 120 may provide links between network node 108 and core network 102. Further, in some examples, backhaul network 120 may provide interconnection between network nodes, such as network node 108. Various types of backhaul interfaces may be employed, such as a direct physical connection, a virtual network, or the like using any suitable transport network.

Core network 102 may be a part of wireless communication system 100 and may be independent of the radio access technology used in RAN 104. In some examples, core network 102 may be configured according to 5G standards (e.g., 5GC). In other examples, core network 102 may be configured according to a 4G evolved packet core (EPC), or any other suitable standard or configuration.

Conventionally, a network entity, such as network node 108 or another device in RAN 104, specifies flow-to-bearer mappings that UE 106 is to apply. The network entity may dynamically update the flow-to-bearer mappings at UE 106 through setting a Reflective Quality of Service (QoS) Indicator or Reflective QoS flow to DRB mapping indicator (RQI/RDI) to 1 when the network entity changes the downlink flow-to-bearer mapping. However, as previously discussed, the inability of UE 106 to change flow-to-bearer mappings results in several shortcomings.

As described herein, UE 106 may obtain a flow and perform a bearer selection process to select a data radio bearer for transmission of the flow from among a plurality of data radio bearers configured for use by UE 106 to transmit flows on a network. A radio of UE 106 may be configured to transmit at least some of the flow on the selected data radio bearer. UE 106 may select the flow-to-bearer mapping dynamically based on a configuration of allowed mappings. In some examples, UE 106 may select the flow-to-bearer mapping dynamically based on configured performance indicators. By allowing UE 106 to perform the bearer selection process, UE 106 may be able to transmit the flow on a DRB so that overall transmission rates may be increased. In some examples, the techniques of this disclosure do not require any new signaling from UE 106 to the network entity. Rather, the network entity may infer the flow-to-bearer mapping from SDAP headers or other QoS flow labels.

The bearer selection process may select the data radio bearer based on one or more factors, such as observed UE performance, a prediction regarding bursts in the flow, a traffic classification for the flow, resource allocation of the plurality of data radio bearers, a prioritized bit rate of the flow, a bucket size duration, priorities of the plurality of data radio bearers, observed congestion or latency of the plurality of data radio bearers, or radio conditions of the plurality of data radio bearers. Bucket Size Duration (BSD) is a traffic control algorithm used in networking to manage network congestion. In some examples, as part of performing the bearer selection process, UE 106 applies one or more trained machine learning (ML) models to select, from among the plurality of data radio bearers, the data radio bearer for transmission of the flow.

UE 106 may report flow-to-bearer mapping information to one or more network entities, such as network node 108 (which may be a scheduling entity). The flow-to-bearer mapping information indicates mapping of flows to DRBs. Thus, UE 106 may transmit a notification to a network entity that the selected data radio bearer has been selected for the flow. The flow-to-bearer mapping information may be used to train the one or more ML models. In some examples, UE 106 uses the flow-to-bearer mapping information to train the one or more ML models. In some examples, other devices, such as network node 108 or another device, uses the flow-to-bearer mapping information to train the one or more ML models.

In some examples, the flow-to-bearer mapping information includes additional information. For instance, the flow-to-bearer mapping information may include metadata, such as timestamps indicating when flows were mapped to DRBs. In some examples, the flow-to-bearer mapping information may include information regarding how many times the flows violate QoS requirements for the flows, data quantifying aspects of violations of QoS requirements of flows, and so on. In some examples, the flow-to-bearer mapping information may include information regarding the performance of the flows in terms of throughput, latency, loss, timeouts, fairness between flows, and so on. In some examples, the flow-to-bearer mapping information may include information regarding underutilization or overutilization of different logical channels, such as real bit rate compared to prioritized bit rates for the logical channels. In some examples, the flow-to-bearer mapping information may include one or more measures of DRB congestion that may lead to negative user plane events, such as packet discards, flow control events, or packet drops.

In some examples, training examples may be generated based on the flow-to-bearer mapping information. The training examples may include training input data and expected output data. The training input data of a training example may include information about a flow, such as QoS requirements of the flow. The training information data of the training example may also include information regarding current flow-to-DRB assignments of UE 106, such as a quantity of flows assigned to the DRBs, expected bandwidth requirements of other flows, current network congestion conditions, and so on. A training system may use the training input data as input to the one or more ML models. The one or more ML models may generate an output indicating one or more predictions regarding the flow if the flow were to be assigned to a DRB. The training system may apply an error function that generates an error value based on differences between the predicted values and observed values in the flow-to-bearer mapping information. In an example where the ML models include a neural network model, The training system may use a backpropagation process to update weights of inputs to artificial neurons of the neural network model based on a gradient of the error function. Updating the weights in this way may increase the accuracy of the predictions. Examples of predictions may include quantities of times the flows violate QoS requirements for the flows, data quantifying aspects of violations of QoS requirements of flows, information regarding the performance of the flow, information regarding underutilization or overutilization of different logical channels, measures of DRB congestion measured after the flow was assigned to the DRB, and so on.

In some examples, UE 106 may report information to the one or more network entities regarding whether UE 106 is using artificial intelligence/machine learning (AI/ML) behavior to assign flows to DRBs. The one or more network entities may use the information regarding whether UE 106 is using AI/ML behavior to assign flow to DRBs in one or more ways. For example, the one or more network entities determine, based on network conditions and based on the information regarding whether UE 106 is using AI/ML behavior to assign flow to DRBs, whether to instruct UE 106 to disable the AI/ML behavior and use a default pattern for assigning flows to DRBs. In some examples, the one or more network entities determine, based on network conditions and based on the information regarding whether UE 106 is using AI/ML behavior to assign flow to DRBs, whether to instruct UE 106 to start using the AI/ML behavior to assign flows to DRBs.

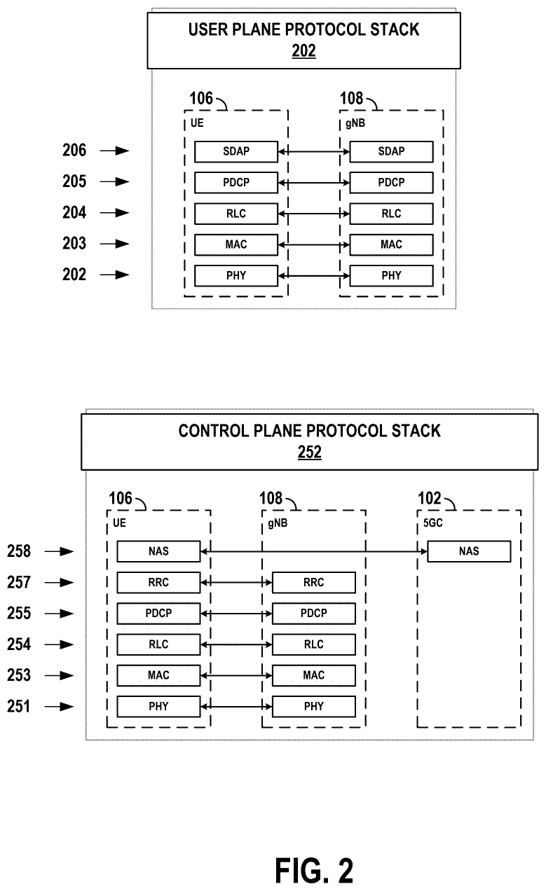

FIG. 2 is a schematic illustration of a user plane protocol stack 202 and a control plane protocol stack 252 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS 258) and Access Stratum (AS, 202-206 and 251-257) layers and protocols. NAS 258 provides upper layers, for signaling between UE 106 and a core network 102 (referring to FIG. 1). AS protocol 202-206 and 252-257 provides lower layers, for signaling between RAN 104 (e.g., a gNB or other network node 108) and the UE 106.

In the example of FIG. 2, a radio protocol architecture is illustrated with a user plane protocol stack 202 and a control plane protocol stack 252, showing their respective layers or sublayers. Radio bearers between network node 108 and UE 106 may be categorized as data radio bearers (DRB) for carrying user plane data, corresponding to user plane protocol 202; and signaling radio bearers (SRB) for carrying control plane data, corresponding to the control plane protocol 252.

In the AS, both user plane protocol stack 202 and control plane protocol stack 252 include a physical layer (PHY) 202/251, a medium access control layer (MAC) 203/253, a radio link control layer (RLC) 204/254, and a packet data convergence protocol layer (PDCP) 205/255. PHY 202/251 is the lowest layer and implements various physical layer signal processing functions. The MAC layer 203/253 provides multiplexing between logical and transport channels and is responsible for various functions. For example, the MAC layer 203/253 is responsible for reporting scheduling information, priority handling and prioritization, and error correction through hybrid automatic repeat request (HARQ) operations. RLC layer 204/254 provides functions such as sequence numbering, segmentation and reassembly of upper layer data packets, and duplicate packet detection. RLC layer 204/254 and MAC layer 203/253 may operate using logical channels according to a leaky bucket algorithm that helps manage data traffic by controlling the average and peak rates of data transmission. PDCP layer 205/255 provides functions including header compression for upper layer data packets to reduce radio transmission overhead, security by ciphering the data packets, and integrity protection and verification.

In user plane protocol stack 202, a service data adaptation protocol (SDAP) layer 206 provides services and functions for maintaining a desired quality of service (QoS). And in control plane protocol stack 252, a radio resource control (RRC) layer 257 includes a number of functional entities for routing higher layer messages, handling broadcasting and paging functions, establishing and configuring radio bearers, NAS message transfer between NAS and UE, etc.

A NAS protocol layer 258 provides for a wide variety of control functions between the UE 106 and core network 102. These functions include, for example, registration management functionality, connection management functionality, and user plane connection activation and deactivation.

In user plane protocol stack 202, SDAP layer 206 provides services and functions for maintaining a desired quality of service (QoS), including mapping between a QoS flow and a sidelink data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service. In control plane protocol stack 252, a radio resource control (RRC) layer 257 includes a number of functional entities for transferring RRC messages between paired UEs, for maintenance and release of an RRC connection between UEs, and for detection of a sidelink radio link failure.

In some examples, a physical layer multiplexes and maps the physical channels to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

Some modern wireless networks, such as a 5G NR network, may provide radio resources over a very wide frequency range. However, any given UE accessing a cell may have bandwidth capabilities that do not span this entire range. Accordingly, a RAN may configure a part or a portion of a carrier for that UE, called a bandwidth part (BWP), which has a bandwidth less than or equal to that UE's capabilities. A RAN may configure a UE with several BWPs (in some examples, up to four BWPs); although typically only a single BWP at a time is an active BWP. In this disclosure, a BWP refers to a set of wireless resources (e.g., a contiguous set of PRBs) selected as a subset of the wireless resources on a given carrier. In some examples, a BWP may be selected from among a contiguous set of resource blocks that share a common numerology (e.g., subcarrier spacing) on a given carrier. The RAN generally does not expect a UE to communicate outside an active BWP.

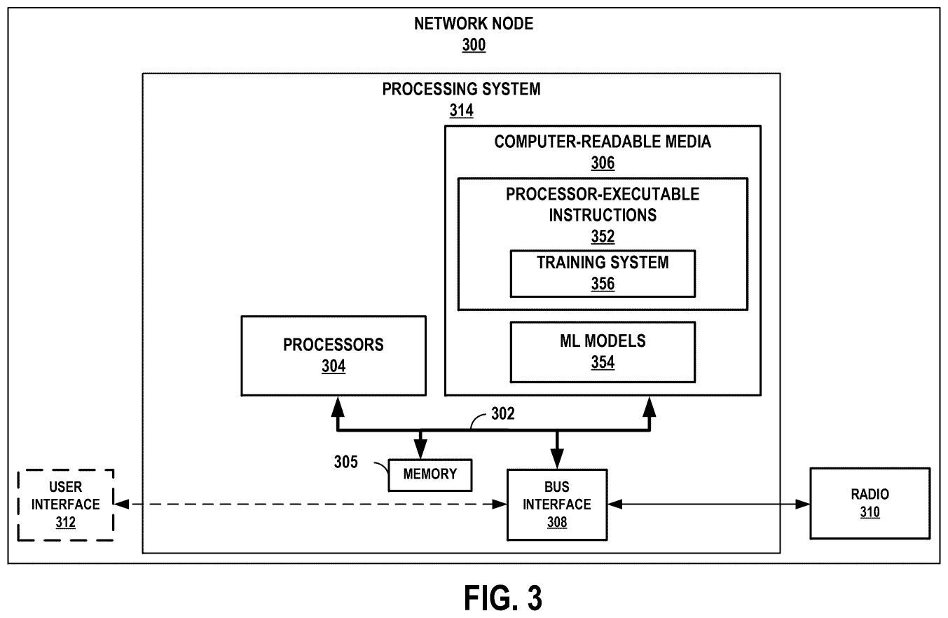

FIG. 3 is a block diagram illustrating an example of a hardware implementation for a network node 300 employing a processing system 314. For example, network node 300 may be a user equipment (UE) as illustrated in FIG. 1. In another example, network node 300 may be a network entity, such as a base station, as illustrated in FIG. 1.

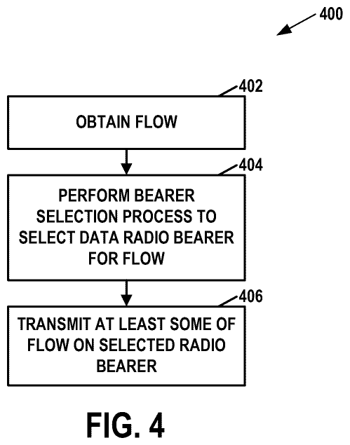

Network node 300 may include a processing system 314 having one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, network node 300 may be configured to perform any one or more of the functions described herein. For example, processors 304, as utilized in network node 300, may be configured (e.g., in coordination with one or more memories 305) to implement any one or more of the processes and procedures described below and illustrated in FIG. 4.

Processing system 314 may be implemented with a bus architecture, represented generally by a bus 302. Bus 302 may include any number of interconnecting buses and bridges depending on the specific application of processing system 314 and the overall design constraints. Bus 302 communicatively couples together various circuits including one or more processors (represented generally by processors 304), memories 305, and one or more computer-readable media (represented generally by computer-readable storage media 306). Bus 302 may also link various other circuits such as timing sources, peripherals, voltage regulators, and power management circuits, which are well known in the art, and therefore, will not be described any further. A bus interface 308 provides an interface between bus 302 and a radio 310. Radio 310 provides a communication interface or means for communicating with various other apparatus over a transmission medium. Depending upon the nature of the apparatus, a user interface 312 (e.g., keypad, display, speaker, microphone, joystick) may also be provided. User interface 312 may be optional, and some examples, such as examples where network node 300 is a base station, may omit user interface 312.

Processors 304 may be responsible for managing bus 302 and general processing, including the execution of software stored on computer-readable storage media 306. The software, when executed by processors 304, causes processing system 314 to perform the various functions described below for any particular apparatus. Processors 304 may also use computer-readable storage media 306 and memories 305 for storing data that processors 304 manipulate when executing software.

Processors 304 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on computer-readable media storage 306. Computer-readable storage media 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Computer-readable media 306 may reside in processing system 314, external to processing system 314, or distributed across multiple entities including processing system 314. Computer-readable storage media 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage media 306 may store computer-executable code that includes processor-executable instructions 352 that configure network node 300 for various functions, including, e.g., perform a bearer selection process to select, from among a plurality of data radio bearers configured for use by the UE to transmit flows on a network, a data radio bearer for transmission of the flow. In the example of FIG. 3, processor-executable instructions 352 may include instructions associated with a training system 356. Training system 356 may train one or more of ML model 354, e.g., as described elsewhere in this disclosure.

Additionally, computer-readable storage media 306 may store one or more ML models 354. Processors 304 may be configured to apply ML model 354 to select a data radio bearer for transmission of a flow from among the plurality of data radio bearers.

In one configuration, network node 300 is an apparatus for wireless communication includes means for obtaining a flow. The apparatus includes means (e.g., processors 304) for performing a bearer selection process to select, from among a plurality of data radio bearers configured for use by the UE to transmit flows on a network, a data radio bearer for transmission of the flow. The apparatus may further include means (e.g., radio 310) for a transmitting at least some of the flow on the selected data radio bearer.

In the above examples, the circuitry included in processors 304 is merely provided as an example, and other means for carrying out the described functions may be included within various aspects of the present disclosure, including but not limited to the instructions stored in computer-readable storage media 306, or any other suitable apparatus or means described in FIG. 1, and utilizing, for example, the processes and/or algorithms described herein in relation to FIG. 4.

FIG. 4 is a flowchart illustrating an exemplary process 400 for wireless communication in accordance with some aspects of the present disclosure. As described below, a particular implementation may omit some or all illustrated features, and may not require some illustrated features to implement all embodiments. In some examples, UE 106 (FIG. 1) may be configured to carry out process 400. In some examples, any suitable apparatus or means for carrying out the functions or algorithm described below may carry out process 400.

In the example of FIG. 4, UE 106 obtains a flow (402). In some examples, UE 106 may obtain the flow from a higher layer of a communication stack. For instance, UE 106 may obtain the flow from an application layer.

Furthermore, UE 106 may perform a bearer selection process to select, from among a plurality of data radio bearers configured for use by UE 106 to transmit flows on a network, a data radio bearer for transmission of the flow (404).

In some examples, UE 106 may apply one or more trained ML models 354 as part of the bearer selection process. For instance, UE 106 may apply one or more trained ML models 354 to generate one or more predictions regarding the flow. UE 106 may select, based on the one or more predictions, the data radio bearer from among the plurality of data radio bearers. The one or more ML models 354 may receive input data that include information about the flow, information about existing flows assigned to DRBs, and/or other information. The ML model may generate one or more predictions regarding the flow based on the input data. For example, the ML model may generate a prediction regarding whether the flow is likely to include bursts of traffic flow. UE 106 may select a DRB for transmission of the flow based on the one or more predictions. For example, UE 106 may select a first DRB for the flow if a prediction indicates that the flow is likely to include bursts of traffic flow and may select a second DRB for the flow if the prediction indicates that the flow is not likely to include bursts of traffic flow.

In some examples, the bearer selection process selects the DRB for transmission of the flow based on an internal UE traffic classification mechanism. For instance, UE 106 may apply a determinative algorithm that assigns flows to DRBs based on classes of data that the flows contain. For example, the bearer selection process may assign flows containing TCP acknowledgements to a first DRB and assign flows containing low priority traffic to a second DRB.

In some examples, the bearer selection process selects the DRB for transmission of the flow based on contextual information regarding an application associated with the flow, as well as observations and predictions about resource allocation and radio conditions of different bearers. The contextual information regarding the application may include information regarding the type of application (e.g., a media streaming application, a web application, etc.). In some examples, UE 106 may collect information about resource allocation among the DRBs, such as how many flows are assigned to each of the DRBs, average amounts of data transmitted on the DRBs, maximum amounts of data transmitted on the DRBs, and so on. Examples of radio conditions may include congestion, latency, packet drop rates, and so on.

In some examples, radio 310 is further configured to receive bearer configuration information from a network entity, such as network node 108 (which may be a scheduling entity). In other words, the network entity may send bearer configuration information to UE 106. UE 106 may perform the bearer selection process in accordance with the bearer configuration information. The bearer configuration information may include specify ranges and performance indicators (e.g., key performance indicators (KPI)) that limit how ML models 354 to select DRBs for flows. For example, the bearer configuration information may include information indicating one or more of: a default data radio bearer for transmission of the flow, a set of one or more data radio bearers in the plurality of data radio bearers from which the selected data radio bearer can be selected, whether traffic of the flow can be split among two or more data radio bearers of the plurality of data radio bearers, a minimum time that UE 106 must wait before selecting a different data radio bearer for transmission of the flow, or whether the bearer selection process is usable to select the data radio bearer for transmission of the flow.

In some examples, radio 310 of UE 106 is further configured to receive one or more performance indicators from a network entity. UE 106 may perform the bearer selection process in accordance with the one or more performance indicators. The performance indicators may be configured on a per-DRB basis or a per-PDCP entity basis. Example performance indicators may include one or more of: a maximum total data rate that can be carried on the data radio bearer, a limit on a quantity of protocol data units (PDUs) that are discardable in the data radio bearer, a target quantity of low-importance PDUs that are discardable in the data radio bearer, a target for unused resources of the data radio bearer, a target mean delay experienced by PDUs of the data radio bearer, or a target cumulative block error rate (BLER) for the data radio bearer, or flow-related performance indicators (e.g., a throughput of the flow, a delay of the flow, or an error rate of the flow). Other example performance indicators may include transport layer metrics collected by UE 106 outside of RAN 104. Such other performance indicators may include metrics regarding duplicate TCP ACKs, the present of Low Latency Low Loss Scalable Throughput (L4S) explicit communication transfer (ECT) bits, transform level throughput, delay, loss, and so on.

To perform the bearer selection process in accordance with the one or more performance indicators, UE 106 may generate predicted performance indicator values. The predicted performance indicator values are predicted values that the performance indicators would have if the flow were assigned to a DRB. For example, UE 106 may predict whether a maximum total data rate that can be carried on a DRB would be exceeded if the flow were assigned to the DRB. In another example, UE 106 may predict what the discard rate of a DRB would be if the flow were assigned to the DRB. In another example, UE 106 may predict amounts of unused resources that would occur if the flow were assigned to the DRB. UE 106 may predict values of the performance indicators for multiple DRBs. For instance, if the predicted performance indicator values do not satisfy the values of the performance indicators received from the network entity if the flow were assigned to a first DRB, UE 106 may generate second predicted performance indicator values. The second predicated performance indicator values are predicted values of the performance indicators if the flow were assigned to a second DRB. UE 106 may then determine again whether the second predicted performance indicator values would satisfy the values of the performance indicators received from the network entity, and so on. In this way, UE 106 may identify a DRB, from among a plurality of DRBs, where the predicted performance indicator values satisfy the received values of the performance indicators when the flow is assigned to the DRB.

In some examples, UE 106 uses one or more of ML models 354 to predict the values of the performance indicators. Inputs to the one or more ML models 354 may include QoS information regarding a flow, information about current conditions of the DRBs, information about network conditions, and/or other information. ML models 354 for predicting the values of the performance indicators may include neural network models or other types of ML models. In some examples, UE 106 may apply one or more fixed formulas or algorithms to predict the values of the performance indicators based on the inputs.

In some examples, UE 106 may select a DRB for a flow based on both at least one range and at least one performance indicator. For example, UE 106 may receive performance indicators indicating a minimum and a maximum prioritized bit rate for a flow. In this example, UE 106 may predict minimum and maximum prioritized bit rates for a flow if the flow were assigned to a DRB. UE 106 may determine whether the predicted minimum and maximum prioritized bit rates for the flow satisfy the received minimum and maximum prioritized bit rates. In some examples, UE 106 may receive a bucket size duration parameter that is used to calculate the prioritized bit rate and an associated logical channel priority used for MAC PDU building in received grants.

In some examples, one or more of the performance indicators may be established for one or more PDU sets. A PDU set is a collection of packets (i.e., PDUs) carrying a media unit. Performance indicators for PDU sets may be significant because the 6G QoS framework is expected to give special attention to extended reality (XR). In applications using XR, it is common that one unit of a media layer (i.e., a media unit) is delivered via multiple packets. Information support PDU Set level QoS handling may include PDU Set information and PDU Set level QoS parameters. The PDU Set information may include PDU Set Sequence Number, End PDU of the PDU Set, PDU Sequence Number within a PDU Set, PDU Set Size and PDU Set importance. The PDU Set level QoS parameters may include a PDU Set Delay Budget (PSDB) and a PDU Set Error Rate (PSER) are introduced to control the delay and error rate on PDU Set level instead of PDU level. Example performance indicators for PDU sets may include one or more of the following:
A PDU Set Discard Metric (PSDB) based on Delay budget
A PDU Set Discard Metric based on Importance (PSI)
A PDU Set Integrity Handling Indicator Metric based discard (PSIHI)
A PDU Set Error Rate (PSER)
A MultiModal (MM) Flow ID specific (as one flow discard can result in other flow discard due to MM Flow ID relation)
   UE 106 may generate predicted values of performance indicators for PDU sets for one or more possible assignments of a flow that contain PDU sets to DRBs. UE 106 may assign the flow to a PDU for which the predicted values of the performance indicators for PDU sets satisfy the received values of the performance indicators for the PDU sets.

In some examples, UE 106 and one or more network entities collect and exchange KPIs related to performance of flow-to-bearer mappings. For example, UE 106 may collect and maintain KPIs such as discard rates for a flow-to-bearer mapping, application throughput for a flow-to-bearer mapping, application latency for a flow-to-bearer mapping, and so on. In some examples, the network entity may determine a flow-to-bearer mapping and compare a bit rate for the flow-to-bearer mapping to a prioritized bit rate that the network entity has allocated to the flow. In such examples, the network entity may send data to UE 106 regarding the comparison. UE 106 may update the flow-to-bearer mapping based on the data regarding the comparison.

In some examples, UE 106 transmits a request to the network entity to assign the flow to the selected DRB. In other words, UE 106 can either ask the network entity to perform the change or explicitly inform the network of the change. UE 106 may subsequently receive a response from the network entity indicating whether UE 106 is permitted to assign the flow to the selected data radio bearer. This may allow the network entity to retain some control over the flow-to-bearer mappings while still allowing UE 106 to dynamically update the flow-to-bearer mappings. In some examples, UE 106 may transmit the request via one or more of MAC control element (MAC CE), SDAP, control PDU, control signaling, or other types of signaling. The network entity may accept or reject the proposed flow-to-bearer mappings. The network entity may signal whether the flow-to-bearer mappings are accepted or rejected, e.g., using SDAP signaling. In some examples, the request includes data specifying a reason for selecting the selected data radio bearer for transmission of the flow. Example reasons may include the flow being bursty, the flow hoarding bearer resources, and so on. For example, the request may contain a “cause value” (e.g., a few bits that map to an agreed cause, e.g., bursty flow hoarding bearer resources).

Radio 310 of UE 106 may transmit at least some of the flow on the selected DRB (406). For instance, radio 310 may transmit at all packets of the flow on the selected DRB. In some examples, radio 310 may transmit some packets of the flow on the selected DRB and other packets of the flow on another DRB.

In some examples, radio 310 of UE 106 is configured to transmit capability reporting information to a network entity, such as network node 108 (which may be a scheduling entity). The capability reporting information may indicate whether UE 106 is configured to perform the bearer selection process. For example, the capability reporting information may include information indicating one or more of: a maximum number of flows supported by UE 106, a maximum number of DRBs supported by UE 106, data indicating capabilities of ML models 354, whether UE 106 has an ability to identify and split traffic within a flow, a maximum data rate per flow, and so on. In some examples, the network entity uses the capability reporting information to determine applicable bearer configuration information that the network entity may send the UE 106.

In some examples, UE 106 may be configured to, based on determining that the one or more performance indicators are not satisfied during a time that the at least some of the flow is transmitted on the selected data radio bearer, select a default data radio bearer for transmission of the flow. Radio 310 of UE 106 may then transmit the flow on the default data radio bearer. In other words, UE 106 may be configured with a fallback behavior in the event that UE 106 cannot maintain the KPI for a flow. For instance, UE 106 may start to use the fallback behavior if UE 106 cannot maintain the KPI for a flow with any mapping of the flow to any DRB configured at UE 106. In some examples, the fallback behavior may be a legacy non-AI/ML behavior in which UE 106 uses a configured default DRB for the flow. In some examples, UE 106 is configured to transmit data to the network entity when a flow-to-bearer mapping selected by ML models 354 violates a KPI. Transmitting such data may help a network manager evaluate an effectiveness of ML model 354. In some examples, the data may be used to generate training data for use in further training ML models 354.

In example aspects, an ML model, such as ML models 354, may be trained prior to, or at some point following, operation of the ML model, such as ANN 500, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

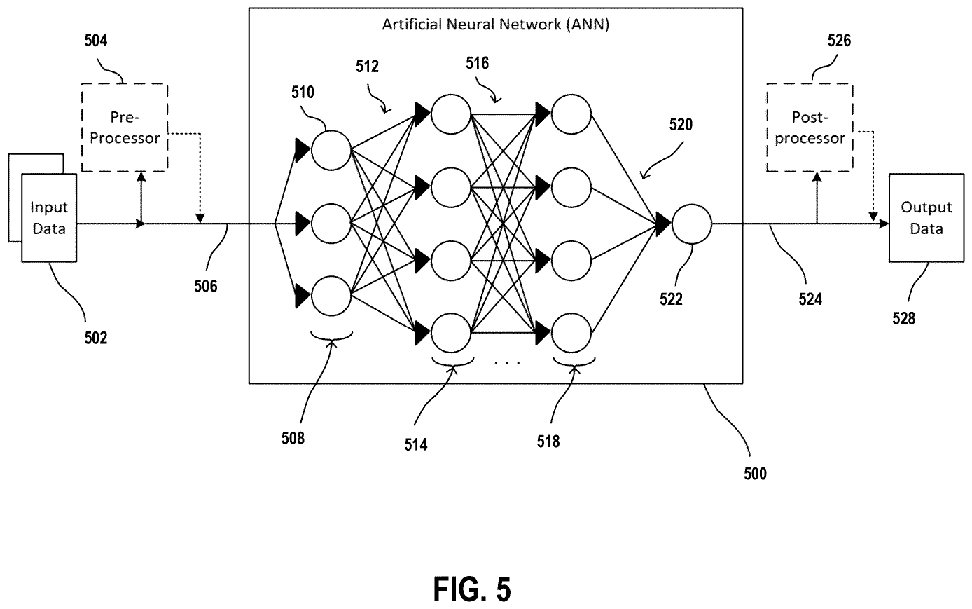

FIG. 5 is an illustrative block diagram of an example machine learning (ML) model represented by an artificial neural network (ANN) 500. ANN 500 may receive input data 506 which may include one or more bits of data 502, pre-processed data output from pre-processor 504 (optional), or some combination thereof. Here, data 502 may include training data, verification data, application-related data, or the like, based, for example, on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, pre-processor 504 may be a ML model, such as an ANN.

ANN 500 includes at least one first layer 508 of artificial neurons 510 to process input data 506 and provide resulting first layer data via connections or “edges” such as edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof.

Post-processor 526 may be included within ANN 500 in some other implementations. Post-processor 526 may, for example, process all or a portion of output data 524 which may result in output data 528 being different, at least in part, to output data 524, as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN.

The structure and training of artificial neurons 510 in the various layers may be tailored to specific requirements of an application. Within a given layer such as first layer 508, second layer 514, or third layer 518 of ANN 500, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 500. The weights and biases of ANN 500 may be adjusted during a training process or during operation of ANN 500. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 506. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 500, may be conducted using training data. Training data may include one or more datasets which ANN 500 may use to identify patterns or relationships. Training data may represent various types of information, including written, visual, audio, environmental context, operational properties, etc. During training, the parameters (such as the weights and biases) of artificial neurons 510 may be changed, such as to minimize or otherwise reduce a loss function or a cost function. A training process may be repeated multiple times to fine-tune ANN 500 with each iteration.

Various ANN model structures are available for consideration. For example, in a feedforward ANN structure, each artificial neuron 510 in layer 514 receives information from the previous layer (such as, one or more artificial neurons 510 in layer 508) and produces information for the next layer (such as, one or more artificial neurons 510 in layer 518). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 500 or other ML models may be implemented in various types of processing circuits along with memory and applicable instructions therein. For example, general purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 500, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

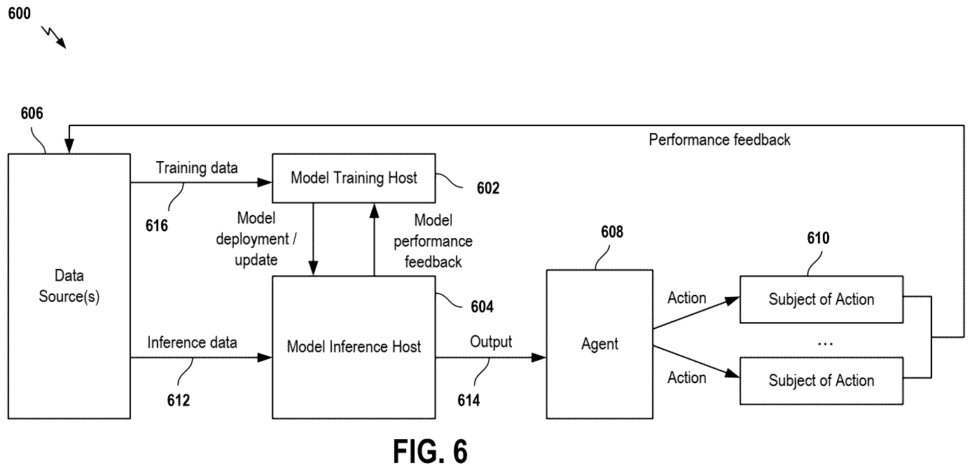

FIG. 6 is an illustrative block diagram of an example ML architecture 600 that may be used for wireless communications in any of the various implementations, processes, environments, networks, or use cases listed above. As illustrated, architecture 600 includes multiple logical entities, such as model training host 602, model inference host 604, one or more data sources 606, and agent 608. Model inference host 604 is configured to run an ML model based on inference data 612 provided by one or more data sources 606. Model inference host 604 may produce output 614, which may include a prediction or inference, such as a discrete or continuous value based on inference data 612, which may then be provided as input to the agent 608.

Agent 608 may represent an element or an entity of a wireless communication system including, for example, a radio access network (RAN), a wireless local area network, a device-to-device (D2D) communications system, etc. As an example, agent 608 may be a user equipment, e.g., UE 106, a base station, e.g., network node 108, or a disaggregated network entity (such as a centralized unit (CU), a distributed unit (DU), or a radio unit (RU)), an access point, a wireless station, a RAN intelligent controller (RIC) in a cloud-based RAN, among some examples. Additionally, agent 608 also may be a type of agent that depends on the type of tasks performed by model inference host 604, the type of inference data 612 provided to model inference host 604, or the type of output 614 produced by model inference host 604.

Agent 608 may perform one or more actions associated with receiving output 614 from model inference host 604. Agent 608 may indicate the one or more actions performed to at least one subject of action 610. For example, agent 608 may assign a flow to a DRB based on output 614. In some cases, agent 608 and the subject of action 610 are the same entity.

Data can be collected from data sources 606, and may be used as training data 616 for training an ML model, or as inference data 612 for feeding an ML model inference operation. Data sources 606 may collect data from various subject of action 610 entities (such as, the UE or the network entity), and provide the collected data to a model training host 602 for ML model training. In some examples, if output 614 provided to agent 608 is inaccurate (or the accuracy is below an accuracy threshold), model training host 602 may provide feedback to model inference host 604 to modify or retrain the ML model used by model inference host 604, such as via an ML model deployment update.

Model training host 602 may be deployed at the same or a different entity than that in which model inference host B104 is deployed. For example, in order to offload model training processing, which can impact the performance of model inference host 604, model training host 602 may be deployed at a model server.

In some other aspects, an ML model is deployed at or on a UE (such as UE 106) for use in performing a bearer selection process.

The following is a non-limiting list of clauses describing aspects of this disclosure.
Clause 1. A User Equipment (UE) for wireless communication, the UE comprising: one or more memories; a radio; and one or more processors coupled to the one or more memories, the one or more processors configured to cause the UE to: obtain a flow; perform a bearer selection process to select, from among a plurality of data radio bearers configured for use by the UE to transmit flows on a network, a data radio bearer for transmission of the flow; and transmit, via the radio, at least some of the flow on the selected data radio bearer.
Clause 2. The UE of clause 1, wherein the bearer selection process selects the data radio bearer based on one or more of: observed UE performance, a prediction regarding bursts in the flow, a traffic classification for the flow, resource allocation of the plurality of data radio bearers, a prioritized bit rate of the flow, a bucket size duration, priorities of the plurality of data radio bearers, observed congestion or latency of the plurality of data radio bearers, or radio conditions of the plurality of data radio bearers.
Clause 3. The UE of any of clauses 1-2, wherein the one or more processors are configured to cause the UE to: transmit, via the radio, a request to a network entity to assign the flow to the selected data radio bearer; and receive, via the radio, a response from the network entity indicating whether the UE is permitted to assign the flow to the selected data radio bearer.
Clause 4. The UE of clause 3, wherein the request includes data specifying a reason for selecting the selected data radio bearer.
Clause 5. The UE of any of clauses 1-4, wherein the one or more processors are configured to cause the UE to transmit, via the radio, a notification to a network entity that the selected data radio bearer has been selected for the flow.
Clause 6. The UE of any of clauses 1-5, wherein the one or more processors are configured to, as part of performing the bearer selection process, cause the UE to: apply one or more trained machine learning (ML) models to generate one or more predictions regarding the flow; and select, based on the one or more predictions, the data radio bearer from among the plurality of data radio bearers.
Clause 7. The UE of clause 6, wherein the one or more processors are further configured to cause the UE to: generate a log of flow-to-bearer mappings and bearer performance data; and train the one or more ML models based on the log of flow-to-bearer mappings and the bearer performance data.
Clause 8. The UE of any of clauses 1-7, wherein the one or more processors are configured to cause the UE to: receive, via the radio, bearer configuration information from a network entity, wherein the bearer configuration information includes information indicating one or more of: a default data radio bearer for transmission of the flow, a set of one or more data radio bearers in the plurality of data radio bearers from which the selected data radio bearer can be selected, whether traffic of the flow can be split among two or more data radio bearers of the plurality of data radio bearers, a minimum time that the UE must wait before selecting a different data radio bearer for transmission of the flow, or whether the bearer selection process is usable to select the data radio bearer for transmission of the flow; and perform the bearer selection process in accordance with the bearer configuration information.
Clause 9. The UE of any of clauses 1-8, wherein the one or more processors are configured to cause the UE to: receive, via the radio, one or more performance indicators from a network entity; and perform the bearer selection process in accordance with the one or more performance indicators.
Clause 10. The UE of clause 9, wherein the one or more performance indicators include one or more of: a maximum total data rate that can be carried on the data radio bearer, a limit on a quantity of protocol data units (PDUs) that are discardable in the data radio bearer, a target quantity of low-importance PDUs that are discardable in the data radio bearer, a target for unused resources of the data radio bearer, a target mean delay experienced by PDUs of the data radio bearer, a target cumulative block error rate for the data radio bearer, a throughput of the flow, a delay of the flow, or an error rate of the flow.
Clause 11. The UE of any of clauses 9-10, wherein the one or more processors are further configured to cause the UE to: based on a determination that the one or more performance indicators are not satisfied during a time that the at least some of the flow is transmitted on the selected data radio bearer, select a default data radio bearer for transmission of the flow; and transmit, via the radio, the flow on the default data radio bearer.
Clause 12. The UE of any of clauses 1-11, wherein the one or more processors are further configured to transmit, via the radio, capability reporting information to a network entity, wherein the capability reporting information indicates whether the UE is configured to perform the bearer selection process.
Clause 13. A method for wireless communication, the method comprising: obtaining, by a User Equipment (UE), a flow; performing, by the UE, a bearer selection process to select, from among a plurality of data radio bearers configured for use by the UE to transmit flows on a network, a data radio bearer for transmission of the flow; and transmitting, by a radio of the UE, at least some of the flow on the selected data radio bearer.
Clause 14. The method of clause 13, further comprising: transmitting, by the radio of the UE, a request to a network entity to assign the flow to the selected data radio bearer; and receiving, by the radio of the UE, a response from the network entity indicating whether the UE is permitted to assign the flow to the selected data radio bearer.
Clause 15. The method of any of clauses 13-14, wherein the performing the bearer selection process comprises: applying one or more trained machine learning (ML) models to generate one or more predictions regarding the flow; and selecting, based on the one or more predictions, the data radio bearer from among the plurality of data radio bearers.
Clause 16. The method of any of clauses 13-15, wherein: the method further comprises receiving, by the radio of the UE, bearer configuration information from a network entity, wherein the bearer configuration information includes information indicating one or more of: a default data radio bearer for transmission of the flow, a set of one or more data radio bearers in the plurality of data radio bearers from which the selected data radio bearer can be selected, whether traffic of the flow can be split among two or more data radio bearers of the plurality of data radio bearers, a minimum time that the UE must wait before selecting a different data radio bearer for transmission of the flow, or whether the bearer selection process is usable to select the data radio bearer for transmission of the flow; and the UE performs the bearer selection process in accordance with the bearer configuration information.
Clause 17. The method of any of clauses 13-16, wherein: the method further comprises receiving, by the radio of the UE, one or more performance indicators from a network entity; and the UE performs the bearer selection process in accordance with the one or more performance indicators.
Clause 18. The method of clause 17, wherein the method further comprises: selecting, by the UE, based on determining that the one or more performance indicators are not satisfied during a time that the at least some of the flow is transmitted on the selected data radio bearer, a default data radio bearer for transmission of the flow; and transmitting, by the radio of the UE, the flow on the default data radio bearer.
Clause 19. The method of any of clauses 13-18, wherein the method further comprises: transmitting, by the radio of the UE, capability reporting information to a network entity, wherein the capability reporting information indicates whether the UE is configured to perform the bearer selection process.
Clause 20. One or more non-transitory computer-readable storage media having processor-executable instructions stored thereon that, when executed by one or more processors of a User Equipment (UE), cause the UE to: obtain a flow; perform a bearer selection process to select, from among a plurality of data radio bearers configured for use by the UE to transmit flows on a network, a data radio bearer for transmission of the flow; and transmit, via a radio of the UE, at least some of the flow on the selected data radio bearer.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-6 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-6 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; a, b and c; and so on. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A User Equipment (UE) for wireless communication, the UE comprising:
one or more memories;
a radio; and
one or more processors coupled to the one or more memories, the one or more processors configured to:
obtain a flow;
perform a bearer selection process to select, from among a plurality of data radio bearers configured for use by the UE to transmit flows on a network, a data radio bearer for transmission of the flow; and
transmit, via the radio, at least some of the flow on the selected data radio bearer.

2. The UE of claim 1, wherein, to perform the bearer selection process, the one or more processors are configured to select the data radio bearer based on one or more of: observed UE performance, a prediction regarding bursts in the flow, a traffic classification for the flow, resource allocation of the plurality of data radio bearers, a prioritized bit rate of the flow, a bucket size duration, priorities of the plurality of data radio bearers, observed congestion or latency of the plurality of data radio bearers, or radio conditions of the plurality of data radio bearers.

3. The UE of claim 1, wherein the one or more processors are configured to:
transmit, via the radio, a request to a network entity to assign the flow to the selected data radio bearer; and
receive, via the radio, a response from the network entity indicating whether the UE is permitted to assign the flow to the selected data radio bearer.

4. The UE of claim 3, wherein the request includes data specifying a reason for selecting the selected data radio bearer.

5. The UE of claim 1, wherein the one or more processors are configured to transmit, via the radio, a notification to a network entity that the selected data radio bearer has been selected for the flow.

6. The UE of claim 1, wherein, to perform the bearer selection process, the one or more processors are configured to:
apply one or more trained machine learning (ML) models to generate one or more predictions regarding the flow; and
select, based on the one or more predictions, the data radio bearer from among the plurality of data radio bearers.

7. The UE of claim 6, wherein the one or more processors are further configured to:
generate a log of flow-to-bearer mappings and bearer performance data; and
train the one or more ML models based on the log of flow-to-bearer mappings and the bearer performance data.

8. The UE of claim 1, wherein the one or more processors are configured to:
receive, via the radio, bearer configuration information from a network entity, wherein the bearer configuration information includes information indicating one or more of: a default data radio bearer for transmission of the flow, a set of one or more data radio bearers in the plurality of data radio bearers from which the selected data radio bearer can be selected, whether traffic of the flow can be split among two or more data radio bearers of the plurality of data radio bearers, a minimum time that the UE must wait before selecting a different data radio bearer for transmission of the flow, or whether the bearer selection process is usable to select the data radio bearer for transmission of the flow; and
perform the bearer selection process in accordance with the bearer configuration information.

9. The UE of claim 1, wherein the one or more processors are configured to:
receive, via the radio, one or more performance indicators from a network entity; and
perform the bearer selection process in accordance with the one or more performance indicators.

10. The UE of claim 9, wherein the one or more performance indicators include one or more of: a maximum total data rate that can be carried on the data radio bearer, a limit on a quantity of protocol data units (PDUs) that are discardable in the data radio bearer, a target quantity of low-importance PDUs that are discardable in the data radio bearer, a target for unused resources of the data radio bearer, a target mean delay experienced by PDUs of the data radio bearer, a target cumulative block error rate for the data radio bearer, a throughput of the flow, a delay of the flow, or an error rate of the flow.

11. The UE of claim 9, wherein the one or more processors are further configured to:
based on a determination that the one or more performance indicators are not satisfied during a time that the at least some of the flow is transmitted on the selected data radio bearer, select a default data radio bearer for transmission of the flow; and
transmit, via the radio, the flow on the default data radio bearer.

12. The UE of claim 1, wherein the one or more processors are further configured to transmit, via the radio, capability reporting information to a network entity, wherein the capability reporting information indicates whether the UE is configured to perform the bearer selection process.

13. A method for wireless communication, the method comprising:
obtaining, by a User Equipment (UE), a flow;
performing, by the UE, a bearer selection process to select, from among a plurality of data radio bearers configured for use by the UE to transmit flows on a network, a data radio bearer for transmission of the flow; and
transmitting, by a radio of the UE, at least some of the flow on the selected data radio bearer.

14. The method of claim 13, further comprising:
transmitting, by the radio of the UE, a request to a network entity to assign the flow to the selected data radio bearer; and
receiving, by the radio of the UE, a response from the network entity indicating whether the UE is permitted to assign the flow to the selected data radio bearer.

15. The method of claim 13, wherein the performing the bearer selection process comprises:
applying one or more trained machine learning (ML) models to generate one or more predictions regarding the flow; and
selecting, based on the one or more predictions, the data radio bearer from among the plurality of data radio bearers.

16. The method of claim 13, wherein:
the method further comprises receiving, by the radio of the UE, bearer configuration information from a network entity, wherein the bearer configuration information includes information indicating one or more of: a default data radio bearer for transmission of the flow, a set of one or more data radio bearers in the plurality of data radio bearers from which the selected data radio bearer can be selected, whether traffic of the flow can be split among two or more data radio bearers of the plurality of data radio bearers, a minimum time that the UE must wait before selecting a different data radio bearer for transmission of the flow, or whether the bearer selection process is usable to select the data radio bearer for transmission of the flow; and
the UE performs the bearer selection process in accordance with the bearer configuration information.

17. The method of claim 13, wherein:
the method further comprises receiving, by the radio of the UE, one or more performance indicators from a network entity; and
the UE performs the bearer selection process in accordance with the one or more performance indicators.

18. The method of claim 17, wherein the method further comprises:
selecting, by the UE, based on determining that the one or more performance indicators are not satisfied during a time that the at least some of the flow is transmitted on the selected data radio bearer, a default data radio bearer for transmission of the flow; and
transmitting, by the radio of the UE, the flow on the default data radio bearer.

19. The method of claim 13, wherein the method further comprises:
transmitting, by the radio of the UE, capability reporting information to a network entity, wherein the capability reporting information indicates whether the UE is configured to perform the bearer selection process.

20. One or more non-transitory computer-readable storage media having processor-executable instructions stored thereon that, when executed by one or more processors of a User Equipment (UE), cause the UE to:
obtain a flow;
perform a bearer selection process to select, from among a plurality of data radio bearers configured for use by the UE to transmit flows on a network, a data radio bearer for transmission of the flow; and
transmit, via a radio of the UE, at least some of the flow on the selected data radio bearer.
